(19) United States
(12) Patent Application Publication
(10) Pub. No.: US 2020/0201717 A1
(43) Pub. Date: Jun. 25, 2020

(54) METHOD FOR RECOVERING A DATABASE, RECOVERY SERVER AND COMPUTER PROGRAMS

(71) Applicant: TmaxData Co.,Ltd., Seongnam-si (KR)

(72) Inventors: Changkeun KIM, Seongnam-si (KR); Hyungrak JO, Seongnam-si (KR); Seung Bin BAE, Seongnam-si (KR)

(21) Appl. No.: 16/290,459

(22) Filed: Mar. 1, 2019

(30) Foreign Application Priority Data
Dec. 21, 2018 (KR) 10-2018-0166849

(51) Int. Cl. G06F 11/14; G06F 7/08

(52) U.S. Cl. CPC G06F 11/1469; G06F 2201/84; G06F 11/1464; G06F 7/08

(57) ABSTRACT

Some exemplary embodiments of the present disclosure disclose a computer program stored in a computer readable storage medium in which the computer program includes commands for allowing a recovery server to perform the following operations including: acquiring at least one redo log file; reading the at least one redo log file and loading redo log data on a program global area (PGA) memory, in which the redo log data includes a plurality of change vectors (CVs) and data block addresses (DBAs) associated with the plurality of CVs; analyzing the redo log data and generating a plurality of CV groups, in which the plurality of respective CV groups is associated with DBAs and the DBAs associated with the plurality of respective CV groups are different from each other; generating a CV sorting group in which the plurality of CV groups is sorted based on the DBA; acquiring at least one DBA associated with the plurality of CV groups included in the CV sorting group by performing multi block read (MBR) in a persistent storage; applying each of the plurality of CV groups included in the CV sorting group to each of the at least one DBA; and performing write for the at least one DBA to which each of the plurality of CV groups is applied by performing multi block write (MBW) in the persistent storage.

### CROSS-REFERENCE TO RELATED APPLICATIONS

This application claims priority to and the benefit of Korean Patent Application No. 10-2018-0166849 filed in the Korean Intellectual Property Office on Dec. 21, 2018, the entire contents of which are incorporated herein by reference.

### TECHNICAL FIELD

The present disclosure relates to a recovery server and computer programs stored in a computer readable storage medium.

### BACKGROUND ART

Businesses of enterprises are rapidly expanding with explosive data growth and the emergence of diverse environments and platforms. As new business environments emerge, more efficient and flexible data services and information processing, and data management functions are needed. In response to these changes, research is continued on databases to solve problems of high performance, high availability, and scalability which are foundations of corporate business implementation.

On the other hand, existing database recovery related technologies recover lost files in a state in which the lost files are loaded on a buffer cache in a failed server. In this case, copying a memory to the buffer cache may reduce a recovery speed.

Therefore, there is a need for a technology that reduces the total database recovery time by efficiently accessing the disk during a database recovery process in the art.

(Patent Document 1) US Patent No. 20060015542

(Patent Document 2) US Patent No. 20110060724

### SUMMARY OF THE INVENTION

The present disclosure has been made in an effort to provide a recovery server and computer programs stored in a computer readable storage medium.

However, technical objects of the present disclosure are not restricted to the technical object mentioned as above. Unmentioned technical objects will be apparently appreciated by those skilled in the art by referencing the following description.

An exemplary embodiment of the present disclosure provides a computer program stored in a computer-readable storage medium. The computer program includes commands for allowing a recovery server to perform the following operations and the operations may include: acquiring at least one redo log file; reading the at least one redo log file and loading redo log data on a program global area (PGA) memory, in which the redo log data includes a plurality of change vectors (CVs) and data block addresses (DBAs) associated with the plurality of CVs; analyzing the redo log data and generating a plurality of CV groups, in which the plurality of respective CV groups is associated with DBAs and the DBAs associated with the plurality of respective CV groups are different from each other; generating a CV sorting group in which the plurality of CV groups is sorted based on the DBA; acquiring at least one DBA associated with the plurality of CV groups included in the CV sorting group by performing multi block read (MBR) in a persistent storage; applying each of the plurality of CV groups included in the CV sorting group to each of the at least one DBA; and performing write for the at least one DBA to which each of the plurality of CV groups is applied by performing multi block write (MBW) in the persistent storage.

The acquiring of the at least one redo log file may include receiving the redo log file from a redo server.

The acquiring of the at least one redo log file may include searching the redo log file from the persistent storage.

The generating of the plurality of CV groups may include classifying the redo log data for each associated DBA, and generating the plurality of CV groups based on a classification result.

The generating of the CV sorting group in which the plurality of CV groups is sorted based on the DBA may include analyzing the DBAs associated with the plurality of respective CV groups, identifying an order of addresses of the associated DBAs based on an analysis result, and generating the CV sorting group based on an identification result.

The acquiring of the at least one DBA associated with the plurality of CV groups included in the CV sorting group by performing the multi block read (MBR) in the persistent storage may include searching the at least one DBA associated with the plurality of CV groups in the persistent storage, and loading the at least one DBA on the PGA memory.

The applying of each of the plurality of CV groups included in the CV sorting group to each of the at least one DBA may include applying each of the plurality of CV groups included in the CV sorting group to he at least one DBA load on the PGA memory.

The generating of the CV sorting group in which the plurality of CV groups is sorted based on the DBA may include sorting at least one CV included in each of the plurality of CV groups in an order of CV generation time.

The applying of each of the plurality of CV groups included in the CV sorting group to each of the at least one DBA may include sequentially applying the at least one CV sorted in the order of the CV generation time to each of the at least one DBA.

The applying of each of the plurality of CV groups included in the CV sorting group to each of the at least one DBA may include applying CV which is changed most recently among the at least one CV sorted in the order of the CV generation time to each of the at least one DBA.

Another exemplary embodiment of the present disclosure provides a recovery server. The server may include: a redo log data processing unit acquiring at least one redo log file, reading the at least one redo log file and loading redo log data on a program global area (PGA) memory, in which the redo log data includes a plurality of change vectors (CVs) and data block addresses (DBAs) associated with the plurality of CVs; a CV group processing unit analyzing the redo log data and generating a plurality of CV groups, in which the plurality of respective CV groups is associated with DBAs and the DBAs associated with the plurality of respective CV groups are different from each other, and generating a CV sorting group in which the plurality of CV groups is sorted based on the DBA; an MBR processing unit acquiring at least one DBA associated with the plurality of CV groups included in the CV sorting group by performing multi block read (MBR) in a persistent storage; a controller applying each of the plurality of CV groups included in the CV sorting group to each of the at least one DBA; and an MBW processing unit performing write for the at least one DBA to which each of the plurality of CV groups is applied by performing multi block write (MBW) in the persistent storage.

Technical solving means which can be obtained in the present disclosure are not limited to the aforementioned solving means and other unmentioned solving means will be clearly understood by those skilled in the art from the following description.

According to an exemplary embodiment of the present disclosure, a recovery server and computer programs stored in a computer readable storage medium can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 illustrates a database management system according to some exemplary embodiments of the present disclosure.

FIG. 2 is a block diagram for a recover server according to some exemplary embodiments of the present disclosure.

FIG. 3 is a flowchart for describing an example in which a recovery server performs recovery of a database according to some exemplary embodiments of the present disclosure.

FIG. 4 is a schematic view of an order in which a recovery server performs recovery of a database according to some exemplary embodiments of the present disclosure.

FIG. 5 is a flowchart for describing an example in which a recovery server creates a change vector (CV) sorting group according to some exemplary embodiments of the present disclosure.

FIG. 6 is a schematic view of a method in which a recovery server creates a change vector (CV) sorting group according to some exemplary embodiments of the present disclosure.

FIG. 7 is a simple and general schematic view for an exemplary computing environment in which some exemplary embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Various aspects and features will be presented by a system which can include one or more apparatuses, terminals, servers, devices, components, and/or modules. It should also be appreciated and recognized that various systems can include additional apparatuses, terminals, servers, devices, components, and/or modules and/or that the various systems cannot include all of apparatuses, terminals, servers, devices, components, modules, and the like discussed in association with the drawings.

“Computer program”, “component”, “module”, “system”, and the like which are terms used in this specification may be used to be compatible with each other and refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers.

The components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment of the present disclosure and the technical spirit of the exemplary embodiment of the present disclosure is not limited by the accompanying drawings.

It is also to be understood that the terminology used in this specification is for the purpose of describing embodiments only and is not intended to limit the present disclosure. In this specification, singular forms include even plural forms unless the context clearly indicates otherwise. It is to be understood that the terms “comprise” and/or “comprising” used in the specification are intended to be inclusive in a manner that does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

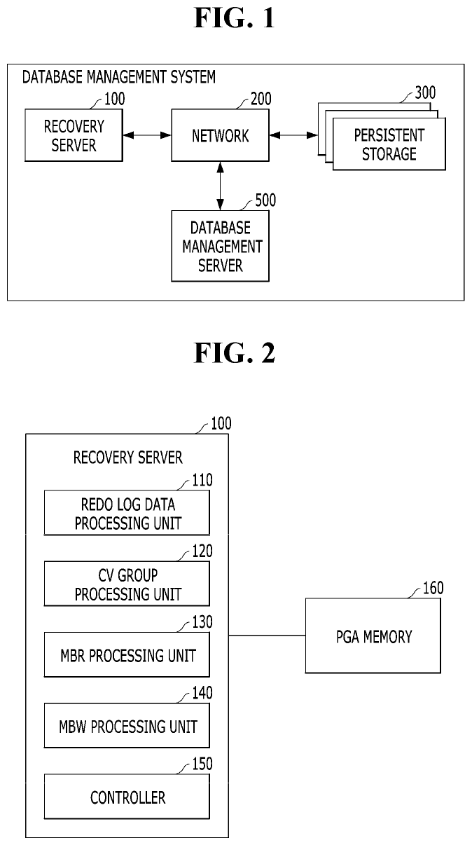

FIG. 1 illustrates a database management system according to some exemplary embodiments of the present disclosure.

Referring to FIG. 1, a database management system (DBMS) may include a recovery server 100, a network 200, a persistent storage 300, and a database management server 500.

According to some exemplary embodiments of the present disclosure, the recovery server 100 and the database management server 500 may include, for example, a predetermined type of computer system or computer device such as a microprocessor, a mainframe computer, a digital processor, a portable device, and a device controller.

The recovery server 100 may include a controller 150 and a program global area (PGA) memory 160. Further, the recovery server 100 and the persistent storage 300 and the recovery server 100 and the database management server 500 may transmit and receive data through a network 200. The network 200 may include a wired network and wireless network and is not limited thereto.

In FIG. 1, one recovery server, one persistent storage 300, and one database management server 500 are exemplarily illustrated, but it will be apparent to those skilled in the art that more recovery servers, persistent storages, and database management servers therethan may also be included in the scope of the present disclosure.

The database management server 500 may recognize that a failure occurs in any one of a plurality of servers (or nodes) in which communication is connected through the network.

Specifically, the database management server 500 may receive a predetermined signal (for example, a heart signal) at a predetermined time interval from each of the plurality of servers. When the database management server 500 recognizes that the predetermined signal is not received from any one of the plurality of servers, the database management server 500 may recognize that the failure occurs in a server to which the predetermined signal is not transmitted. However, a method in which the database management server 500 recognizes the server in which the failure occurs is not limited to the above-described method and it is possible to recognize the server in which the failure occurs through various methods.

When the database management server 500 recognizes that the failure occurs in any one server of the plurality of servers, the database management server 500 may set a specific server among the plurality of servers as the recovery server. Here, the memory of the database management server 500 may store information regarding which server to use as the recovery server when the failure occurs in each of the plurality of servers. Accordingly, when the database management server 500 recognizes that the failure occurs in any one of the plurality of servers, the database management server 500 may recognize which server in the memory of the database management server 500 performs the recovery and then, allow the recognized recovery server to perform the recovery. The reason for performing the recovery is that a change vector (CV) existing in the server in which the failure occurs may not be applied to the persistent storage 300. Here, the CV may represent information on how data is changed in a data block and may be included in a redo log file. Meanwhile, according to some exemplary embodiments, when the database management server 500 recognizes that the failure occurs in any one server of the plurality of servers, the database management server 500 may reboot the server in which the failure occurs and then, allow the rebooted server to perform the recovery. However, the etching resist is not limited thereto.

The recovery server 100 may be a server designated to perform the recovery by the database management server 500. That is, the recovery server 100 may be a server that is rebooted as the server in which the failure occurs and a predetermined server designated to perform the recovery for the server in which the failure occurs.

Meanwhile, the computer program executed in the recovery server 100 according to some exemplary embodiments of the present disclosure may be a CPU, GPGPU, or TPU executable program. A PGA memory 160 included in the recovery server 100 in the present disclosed contents may store a computer program for performing a technique for managing and processing a redo log file or redo log data according to some exemplary embodiments of the present disclosed contents and the stored computer program may be read and driven by the controller 150. Here, the redo log file or redo log data may be a file or data in which a change history generated in the database is written.

The controller 150 of the recovery server 100 may determine to temporarily or permanently store in the PGA memory 160 predetermined data and log information stored in relation with a query which is input into the recovery server 100 from the persistent storage 300 or the redo server 400. The controller 150 may determine to store a data table and/or an index table. The controller 150 may determine a storage location of the stored data and/or log information on the PGA memory 160 or a storage location on the persistent storage 300.

The PGA memory 160 may store a program for an operation of the controller 150 and temporarily or persistently store input/output data (e.g., data block address (DBA) information, change vector (CV) information, etc.). The PGA memory 160 may include at least one type of storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The PGA memory 160 may be operated by the control of the controller 150.

According to some exemplary embodiments of the present disclosure, the controller 150 of the recovery server 100 may perform database recovery by using the PGA memory 160. For example, when the recovery server 100 reads the redo log file, the recovery server 100 may load the redo log data in at least a part of the PGA memory 160 and read DBA from the persistent storage 300, and store the read DBA in at least a part of the PGA memory 160. In addition, the redo log data may be applied to DBAs stored in the PGA memory 160.

According to some exemplary embodiments of the present disclosure, the redo log data may include a plurality of change vectors (CVs) and a data block address (DBA) associated with the plurality of CVs. Here, the CV may include modifications and the DBA for at least one block.

The controller 150 may read at least one redo log file and load the redo log data in the PGA memory 160. In addition, the controller 150 may analyze the DV of the loaded redo log data and sort the respective redo log data. Specifically, the controller 150 may create a CV sorting group based on the address (DBA) of the data block associated with the CV. Further, the controller 150 may acquire at least one DBA from the persistent storage 300 based on the CV sorting group. The controller 150 may perform the recovery by applying the CV included in the CV sorting group to each of at least one DBA acquired.

Here, the controller 150 may acquire adjacent DBAs at a time based on the address of each data block associated with the CV sorting group. In this case, since the controller 150 does not individually acquire the respective adjacent data blocks but acquires the respective adjacent DBAs at a time, the number of access times to the persistent storage 300 may be reduced.

The controller 150 may acquire the DBAs from the persistent storage 300 in an asynchronous scheme. When the recovery server 100 acquires the DBAs in the asynchronous scheme, the recovery server 100 may utilize a maximum bandwidth provided by the persistent storage 300 to reduce a database recovery time.

Meanwhile, when the controller 150 acquires the DBAs from the persistent storage 300 in the synchronous scheme, a read request for other DBAs may be restricted until a read operation for one DBA ends in the persistent storage 300. Accordingly, the recovery server 100 is maintained in an idle state until the read operation ends in the persistent storage 300 and the DBA is thus acquired.

However, according to some exemplary embodiments of the present disclosure, when the recovery server 100 acquires the DBAs in the asynchronous scheme, the read requests for other data blocks may be superimposed and waited in the persistent storage 300 irrespective of whether the read operation for one DBA ends. That is, an operation of recovering the DBA acquired by the recovery server 100 and an operation of reading the DBAs in the persistent storage 300 may be independently performed.

When a time required for an input/output process (a process of requesting and acquiring DBA during a database recovery process) for the persistent storage 300 is longer than a data processing time, a method for acquiring the data block in the asynchronous scheme may reduce the database recovery time.

A detailed description regarding the recovery of the database by the controller 150 of the recovery server will be made in detail later with reference to FIGS. 2 to 6.

The persistent storage 300 may include a non-volatile storage medium which may continuously store predetermined data. For example, the persistent storage 300 may include a storage device based on a flash memory and/or a battery back-up memory in addition to a disk, an optical disk, and a magneto-optical storage device and is not limited thereto.

According to some exemplary embodiments of the present disclosure, the recovery server 100 and the persistent storage 300 may communicate with each other through the network 200. The network 200 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network 200 presented in this specification may use various wireless communication systems such as code division multi access (CDMA), time division multi access (TDMA), frequency division multi access (FDMA), orthogonal frequency division multi access (OFDMA), single carrier-FDMA (SC-FDMA), and other systems. Additionally, the network 200 may include a database link, and as a result, a plurality of recovery servers communicates with each other through the database link to fetch data from another database management apparatus. The techniques described in the present specification may be used in other networks in addition to the aforementioned networks.

The component of the database management system illustrated in FIG. 1 is not limited to the aforementioned exemplary embodiment.

FIG. 2 is a block diagram for a recover server according to some exemplary embodiments of the present disclosure.

According to some exemplary embodiments of the present disclosure, the recovery server 100 may include a redo log data processing unit 110, a CV group processing unit 120, a multi block read (MBR) processing unit 130, a multi block write (MBW) processing unit 140, a controller 150, and a PGA memory 160. However, components illustrated in FIG. 2 are not required in implementing the recovery server 100 and the recovery server 100 described in this specification may thus have components more or less than components listed above.

According to some exemplary embodiments of the present disclosure, the redo log data processing unit 110 may acquire at least one redo log file. Further, the redo log data processing unit 110 may read at least one redo log file and load the redo log data in the PGA memory 160. Here, the redo log data may include a plurality of DVs and DBAs associated with the plurality of CVs.

The CV group processing unit 120 may analyze the redo log data and generate a plurality of CV groups. In addition, the CV group processing unit 120 may generate a CV sorting group in which the plurality of CV groups is sorted based on the DBA associated with each of the plurality of CV groups.

According to some exemplary embodiments of the present disclosure, the MBR processing unit 130 may perform multi block read (MBR) in the persistent storage 300. Specifically, the MBR processing unit 130 may perform the MBR in the persistent storage 300 to acquire at least one DBA associated with the plurality of CV groups included in the CV sorting group. In this case, the controller 150 may apply each of the plurality of CVs included in the CV sorting group to each of at least one DBA.

According to some exemplary embodiments of the present disclosure, the MBW processing unit 140 may perform multi block write (MBW) in the persistent storage 300. Specifically, the MBW processing unit 140 may perform the MBW in the persistent storage 300 and perform write for at least one DBA to which each of the plurality of CV groups is applied. When such write is performed, each of the plurality of CV groups may be applied to the block of the persistent storage 300 associated with the at least one DBA. That is, changed contents written in the redo log file may be applied to the persistent storage 300.

Various embodiments described herein may be implemented in a computer-readable recording medium or a recording medium and a storage medium readable by a device similar to the computer by using, for example, software, hardware, or a combination thereof.

According to hardware implementation, the embodiment described herein may be implemented by using at least one of the application specific integrated circuits (ASICs), the digital signal processors (DSPs), the digital signal processing devices (DSPDs), the programmable logic devices (PLDs), the field programmable gate arrays (FPGAs), the processors, the controllers, the micro-controllers, the microprocessors, and the electric units for performing other functions. In some cases, the embodiments described in the specification may be implemented by the controller 150 itself.

According to software implementation, embodiments such as a procedure and a function described in the specification may be implemented by separate software modules. Each of the software modules may perform one or more functions and operations described in the specification. A software code may be implemented by a software application written by an appropriate program language. The software code may be stored in the PGA memory 160 and executed by the controller 150.

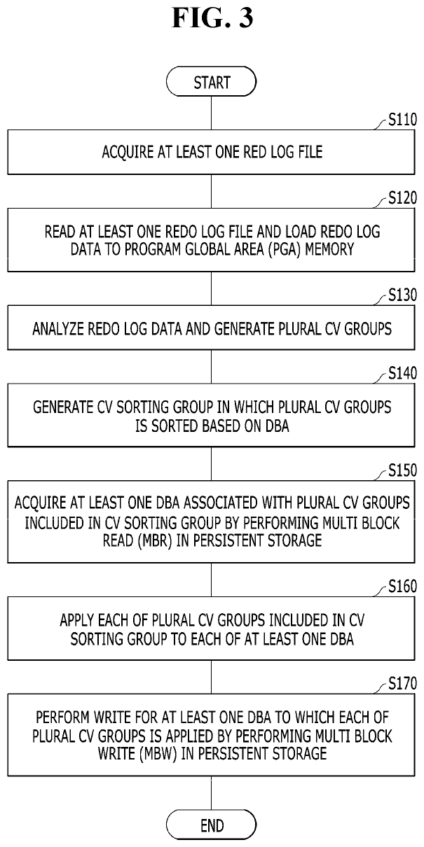

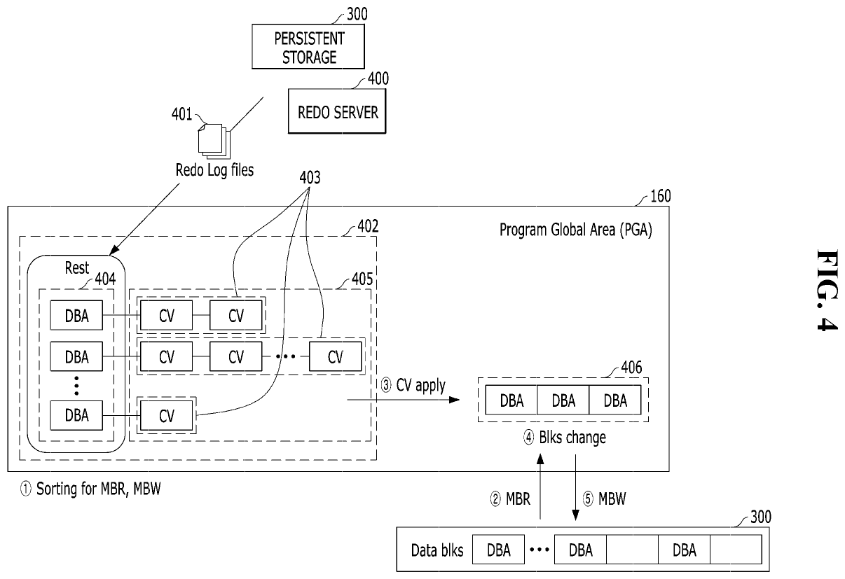

FIG. 3 is a flowchart for describing an example in which a recovery server performs recovery of a database according to some exemplary embodiments of the present disclosure. FIG. 4 is a schematic view of a method in which a recovery server performs recovery of a database according to some exemplary embodiments of the present disclosure.

First, the database management server 500 may recognize that the failure occurs in any one of a plurality of servers (or nodes) in which communication is connected through the network. In this case, the database management server 500 may set another server in which the failure does not occur among the plurality of servers as the recovery server 100, and reboot the server in which the failure occurs and set the rebooted server as the recovery server 100.

Meanwhile, referring to FIG. 3, the redo log data processing unit 110 of the recovery server 100 may acquire at least one redo log file (S110).

As an example, the redo log file may be stored in a redo server. In this case, the redo log data processing unit 110 may receive the redo log file from the redo server.

As another example, the redo log file may be stored in a predetermined address in the persistent storage 300. In this case, the redo log data processing unit 110 may search the redo log file from the persistent storage 300.

However, a method for acquiring the redo log file is not limited to the aforementioned method.

According to some exemplary embodiments of the present disclosure, the redo log data processing unit 110 of the recovery server 100 may read at least one redo log file and load the redo log data on the PGA memory 160 (S120).

Referring to FIG. 4, the redo log data processing unit 110 of the recovery server 100 may acquire a redo log file 401 from either the persistent storage 300 or the redo server 400. In this case, the CV group processing unit 120 of the recovery server 100 can sort the redo log files 401.

Referring back to FIG. 3, the CV group processing unit 120 of the recovery server 100 may analyze the redo log data and generate the CV group (S130). Specifically, the CV group processing unit 120 may classify the redo log data for each associated DBA. Further, the CV group processing unit 120 may generate a plurality of CV groups based on a classification result.

More specifically, referring to FIG. 4, the CV group generated by the CV group processing unit 120 means respective CV groups 403 associated with a plurality of DBAs 404 illustrated in FIG. 4, respectively.

The CV group processing unit 120 of the recovery server 100 may generate a CV sorting group in which the plurality of CV groups is sorted based on the DBA associated with each of the plurality of CV groups.

Specifically, the CV group processing unit 120 may analyze the DBA associated with each of the plurality of CV groups. Further, the CV group processing unit 120 may identify an order of addresses of the associated DBAs based on the analysis result. In addition, the CV group processing unit 120 may generate a CV sorting group in which the CV groups 403 are sorted in the order of the address of the DBA based on an identification result. Here, the CV sorting group means a group 405 in which the respective CV groups 403 associated with the plurality of DBAs 404 illustrated in FIG. 4, respectively are sorted.

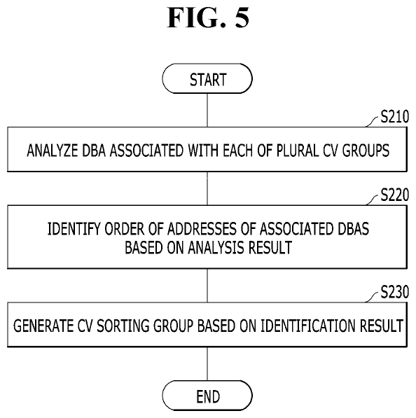

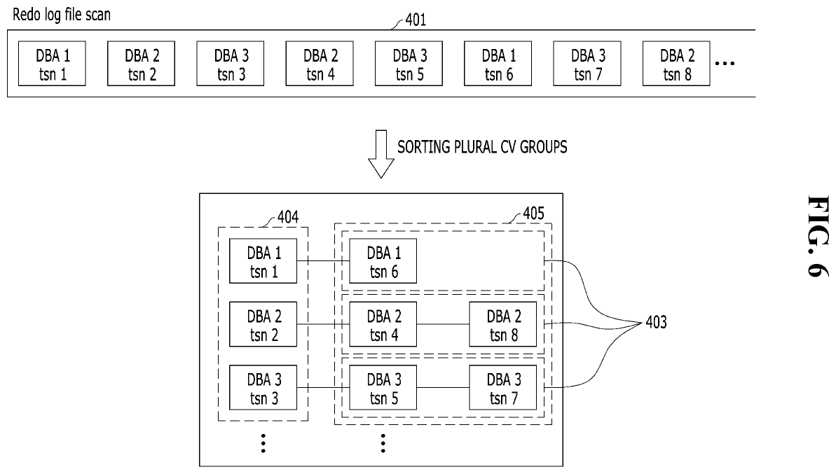

A description of an operation of the CV group processing unit 120 which generates the CV sorting group will be described below in detail with reference to FIGS. 5 and 6.

According to some exemplary embodiments of the present disclosure, the MBR processing unit 130 of the recovery sever 100 may perform multi block read (MBR) in the persistent storage 300. Further, the MBR processing unit 130 may perform the MBR to acquire at least one DBA associated with the plurality of CV groups included in the CV sorting group (S150). Specifically, the MBR processing unit 130 may search at least one DBA associated with the plurality of CV groups in the persistent storage 300. Further, the MBR processing unit 130 may load on the PGA memory 160 at least one DBA associated with the plurality of CV groups, which is searched.

According to some exemplary embodiments of the present disclosure, the controller 150 of the recovery server 100 may apply each of the plurality of CVs included in the CV sorting group to each of at least one DBA (S160). Specifically, the controller 150 may apply each of the plurality of CV groups included in the CV sorting group to at least one DBA loaded on the PGA memory 160. The CV sorting group may be a group generated by sorting at least one CV included in each of the plurality of CV groups in the order of CV generation time by the CV group processing unit 120.

As an example, the controller 150 may sequentially apply at least one CV sorted in the order of the CV generation time to each of at least one DBA. As another example, the controller 150 may apply a CV which is changed most recently among at least one CV sorted in the order of the CV generation time to each of at least one DBA.

According to some exemplary embodiments of the present disclosure, the MBW processing unit 140 of the recovery server 100 may perform multi block write (MBW) in the persistent storage 300 (S170).

Referring to FIG. 4, the MBW processing unit 140 may perform the MBW and perform write for at least one DBA 406 to which each of the plurality of CV groups is applied.

According to some exemplary embodiments of the present disclosure, the recovery server 100 may collect recovery information from a Program Global Area (PGA) memory 160, which is a memory area other than a buffer cache and then, perform the recovery by using the redo log file directly from the PGA memory. That is, the recovery server 100 of the present disclosure may perform the recovery without performing disk read/write in and CV apply to the buffer cache.

Therefore, the recovery server 100 may reduce a total database recovery time by efficiently performing memory use and disk access.

FIG. 5 is a flowchart for describing an example in which a recovery server creates a change vector (CV) sorting group according to some exemplary embodiments of the present disclosure. FIG. 6 is a schematic view of a method in which a recovery server creates a change vector (CV) sorting group according to some exemplary embodiments of the present disclosure.

Referring to FIG. 5, the CV group processing unit 120 of the recovery server 100 may analyze the DBAs associated with the plurality of respective CV groups (S210).

The CV group processing unit 120 may identify an order of addresses of the associated DBAs based on an analysis result (S220).

The CV group processing unit 120 may generate the CV sorting group based on an identification result (S230). The CV group processing unit 120 may generate a CV sorting group in which the CV groups 403 are sorted in the order of the address of the DBA based on the identification result. Here, the CV sorting group means a group 405 in which the respective CV groups 403 associated with the plurality of DBAs 404 illustrated in FIG. 4, respectively are sorted. However, the present invention is not limited thereto and the CV group processing unit 120 may sort a plurality of CV groups by various methods.

Meanwhile, a method for sorting the CV groups in the order of the DBA address will be described below in detail with reference to FIG. 6.

Referring to FIG. 6, the redo log data processing unit 110 of the recovery server 100 may scan the redo log file of the persistent storage 300, acquire the redo log data, and store the acquired redo log data in the PGA memory 160.

For example, the redo log file may include CV in which DBA is 1, CV in which DBA is 2, and CV in which DBA is 3.

According to some exemplary embodiments of the present disclosure, the CV group processing unit 120 of the recovery server 100 may analyze the redo log data and generate the plurality of CV groups. Here, the plurality of respective CV groups may be associated with the DBAs and the DBAs associated with the plurality of respective CV groups may be different from each other.

Specifically, the CV group processing unit 120 may classify the redo log data for each associated DBA. Further, the CV group processing unit 120 may generate the plurality of CV groups based on a classification result. Here, a fact that the CV group processing unit 120 generates the plurality of CV groups may mean that each of the CV groups is arranged according to the address of the DBA associated with each of the plurality of CVs.

However, according to some exemplary embodiments, the CV group processing unit 120 may recognize whether the CV is applied to the persistent storage 300 based on time information tsn when the redo log data is classified for each associated DBA. That is, the recovery server 100 may receive the time information from the database management server 500. Further, the CV group processing unit 120 of the recovery server 100 may recognize CV not applied to the persistent storage 300 based on the time information. In addition, the CV group processing unit 120 may generate a plurality of CV groups by using CV not applied to the persistent storage 300.

Specifically, when the CV group processing unit 120 recognizes that CV before a specific time tsn 3 is applied to the persistent storage 300, the CV group processing unit 120 may generate the plurality of CV groups 403 by using only the CV after the specific time.

For example, when there is only one CV in which DBA is 1 among CVs generated after the specific time tsn 3, the CV group processing unit 120 may generate a CV group associated with “DBA 1” by using only the one CV (CV in which DBA is 1 and tsn is 6). In addition, when the CV in which DBA is 2 among the CVs generated after the specific time tsn 3 is divided into two parts, the CV group processing unit 120 may collect CVs (CV in which DBA is 2 and tsn is 4 and CV in which DBA is 2 and tsn is 8) of two parts and generate the CV group. Meanwhile, when the CV in which DBA is 3 among the CVs generated after the specific time tsn 3 is divided into two parts, the CV group processing unit 120 may collect CVs (CV in which DBA is 3 and tsn is 5 and CV in which DBA is 3 and tsn is 7) of two parts and generate the CV group.

Meanwhile, the CV group processing unit 120 may generate at least one CV sorting group based on the addresses of the DBAs associated with the plurality of CV groups.

Specifically, the CV group processing unit 120 may analyze the DBA associated with each of the plurality of CV groups. Further, the CV group processing unit 120 may identify the order of the addresses of the associated DBAs based on the analysis result. Further, the CV group processing unit 120 may generate the CV sorting group based on the identification result. Here, the CV sorting group may mean a group generated by sorting the DBAs associated with the CV group according to the address order as illustrated in FIG. 6.

For example, the CV group processing unit 120 may perform sorting such that a CV group in which DBA is 1 is followed by a CV group in which DBA is 2. In addition, the CV group processing unit 120 may perform sorting such that the CV group in which DBA is 2 is followed by a CV group in which DBA is 3. The CV groups sorted as such may become a CV sorting group.

However, the CV group processing unit 120 may sort the DBAs in an ascending order of addresses and sort the DBAs in a descending order of addresses as described above. That is, the CV group processing unit 120 may sort the DBAs by various methods.

The MBR processing unit 130 of the recovery server 100 may acquire the DBAs associated with the CV sorting group from the persistent storage 300 at a time. In addition, the recovery server 100 may load the acquired DBAs on the PGA memory 160, continuously apply the CVs associated with the DBAs, and recover the database. Here, each CV may include change histories for the DBAs.

The recovery server 100 classifies and sorts the redo log data for each DBA associated with the CV group, and as a result, the number of read or write times of the DBAs from or to the persistent storage 300 by the recovery server 100 may be reduced.

The steps of FIGS. 3 and 5 described above may be changed in order as necessary, and at least one or more steps may be omitted or added. Further, the aforementioned step is just an exemplary embodiment of the present disclosure and the scope of the present disclosure is not limited thereto.

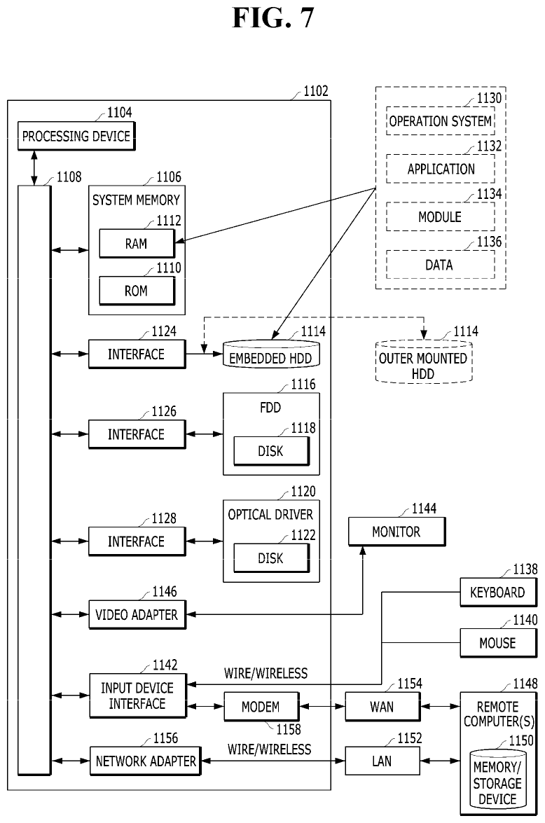

FIG. 7 is a simple and general schematic view for an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable command, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated)—, a magnetic floppy disk drive (FDD) 1116 (for example, for reading from or writing in a mobile diskette 1118), and an optical disk drive 1120 (for example, for reading a CD-ROM disk 1122 or reading from or recorded in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example,at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” include a wireless channel and various other media that can store, possess, and/or transfer command(s) and/or data, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer program stored in a computer readable storage medium, wherein the computer program includes commands for allowing a recovery server to perform operations, and the operations include:
acquiring at least one redo log file;
reading the at least one redo log file and loading redo log data on a program global area (PGA) memory, in which the redo log data includes a plurality of change vectors (CVs) and data block addresses (DBAs) associated with the plurality of CVs;
analyzing the redo log data and generating a plurality of CV groups, in which the plurality of respective CV groups is associated with DBAs and the DBAs associated with the plurality of respective CV groups are different from each other;
generating a CV sorting group in which the plurality of CV groups is sorted based on the DBA;
acquiring at least one DBA associated with the plurality of CV groups included in the CV sorting group by performing multi block read (MBR) in a persistent storage;
applying each of the plurality of CV groups included in the CV sorting group to each of the at least one DBA; and
performing write for the at least one DBA to which each of the plurality of CV groups is applied by performing multi block write (MBW) in the persistent storage.

2. The computer program of claim 1, wherein the acquiring of the at least one redo log file includes receiving the redo log file from a redo server.

3. The computer program of claim 1, wherein the acquiring of the at least one redo log file includes searching the redo log file from the persistent storage.

4. The computer program of claim 1, wherein the generating of the plurality of CV groups includes
classifying the redo log data for each associated DBA, and
generating the plurality of CV groups based on a classification result.

5. The computer program of claim 1, wherein the generating of the CV sorting group in which the plurality of CV groups is sorted based on the DBA includes,
analyzing the DBAs associated with the plurality of respective CV groups,
identifying an order of addresses of the associated DBAs based on an analysis result, and
generating the CV sorting group based on an identification result.

6. The computer program of claim 1, wherein the acquiring of the at least one DBA associated with the plurality of CV groups included in the CV sorting group by performing the multi block read (MBR) in the persistent storage includes
searching the at least one DBA associated with the plurality of CV groups in the persistent storage, and
loading the at least one DBA on the PGA memory, and
the applying of each of the plurality of CV groups included in the CV sorting group to each of the at least one DBA includes
applying each of the plurality of CV groups included in the CV sorting group to the at least one DBA loaded on the PGA memory.

7. The computer program of claim 1, wherein the generating of the CV sorting group in which the plurality of CV groups is sorted based on the DBA includes sorting at least one CV included in each of the plurality of CV groups in an order of CV generation time.

8. The computer program of claim 7, wherein the applying of each of the plurality of CV groups included in the CV sorting group to each of the at least one DBA includes sequentially applying the at least one CV sorted in the order of the CV generation time to each of the at least one DBA.

9. The computer program of claim 7, wherein the applying of each of the plurality of CV groups included in the CV sorting group to each of the at least one DBA includes applying CV which is changed most recently among the at least one CV sorted in the order of the CV generation time to each of the at least one DBA.

10. A recovery server comprising:
a redo log data processing unit acquiring at least one redo log file, reading the at least one redo log file and loading redo log data on a program global area (PGA) memory, in which the redo log data includes a plurality of change vectors (CVs) and data block addresses (DBAs) associated with the plurality of CVs;
a CV group processing unit analyzing the redo log data and generating a plurality of CV groups, in which the plurality of respective CV groups are associated with DBAs and the DBAs associated with the plurality of respective CV groups are different from each other, and generating a CV sorting group in which the plurality of CV groups is sorted based on the DBA;
an MBR processing unit acquiring at least one DBA associated with the plurality of CV groups included in the CV sorting group by performing multi block read (MBR) in a persistent storage;
a controller applying each of the plurality of CV groups included in the CV sorting group to each of the at least one DBA; and
an MBW processing unit performing write for the at least one DBA to which each of the plurality of CV groups is applied by performing multi block write (MBW) in the persistent storage.

11. A method for recovering a database, the method comprising:
acquiring at least one redo log file;
reading the at least one redo log file and loading redo log data on a program global area (PGA) memory, wherein the redo log data includes a plurality of change vectors (CVs) and data block addresses (DBAs) associated with the plurality of CVs;
analyzing the redo log data and generating a plurality of CV groups, in which the plurality of respective CV groups is associated with DBAs and the DBAs associated with the plurality of respective CV groups are different from each other;
generating a CV sorting group in which the plurality of CV groups is sorted based on the DBA;
acquiring at least one DBA associated with the plurality of CV groups included in the CV sorting group by performing multi block read (MBR) in a persistent storage;
applying each of the plurality of CV groups included in the CV sorting group to each of the at least one DBA; and
performing write for the at least one DBA to which each of the plurality of CV groups is applied by performing multi block write (MBW) in the persistent storage.

12. The method of claim 11, wherein the acquiring of the at least one redo log file includes receiving the redo log file from a redo server.

13. The method of claim 11, wherein the acquiring of the at least one redo log file includes searching the redo log file from the persistent storage.

14. The method of claim 11, wherein the generating of the plurality of CV groups includes
classifying the redo log data for each associated DBA, and
generating the plurality of CV groups based on a classification result.

15. The method of claim 11, wherein the generating of the CV sorting group in which the plurality of CV groups is sorted based on the DBA includes
analyzing the DBAs associated with the plurality of respective CV groups,
identifying an order of addresses of the associated DBAs based on an analysis result, and
generating the CV sorting group based on an identification result.

16. The method of claim 11, wherein the acquiring of the at least one DBA associated with the plurality of CV groups included in the CV sorting group by performing the multi block read (MBR) in the persistent storage includes
searching the at least one DBA associated with the plurality of CV groups in the persistent storage, and
loading the at least one DBA on the PGA memory, and
the applying of each of the plurality of CV groups included in the CV sorting group to each of the at least one DBA includes
applying each of the plurality of CV groups included in the CV sorting group to the at least one DBA load on the PGA memory.

17. The method of claim 11, wherein the generating of the CV sorting group in which the plurality of CV groups is sorted based on the DBA includes sorting at least one CV included in each of the plurality of CV groups in an order of CV generation time.

18. The method of claim 17, wherein the applying of each of the plurality of CV groups included in the CV sorting group to each of the at least one DBA includes sequentially applying the at least one CV sorted in the order of the CV generation time to each of the at least one DBA.

19. The method of claim 17, wherein the applying of each of the plurality of CV groups included in the CV sorting group to each of the at least one DBA includes applying CV which is changed most recently among the at least one CV sorted in the order of the CV generation time to each of the at least one DBA.
